(19) United States
(12) Patent Application Publication
(10) Pub. No.: US 2023/0394421 A1
(43) Pub. Date: Dec. 7, 2023

(54) TRACKING SYSTEM AND DEVICES, AND METHODS THEREIN

(71) Applicant: Jeti Services AB, Lidingö (SE)

(72) Inventor: Johan EDGREN, Lidingö (SE)

(21) Appl. No.: 18/246,535

(22) PCT Filed: Sep. 27, 2021
(86) PCT No.: PCT/SE2021/050940

§ 371 Date: Mar. 24, 2023

(30) Foreign Application Priority Data
Sep. 25, 2020 (SE) 2051117-6

(51) Int. Cl. G06Q 10/0833; G06Q 10/047

(52) U.S. Cl. CPC G06Q 10/0833; G06Q 10/047

(57) ABSTRACT

A system, tracking devices, and methods therein are provided for tracking an item during transportation. A wireless intelligent tracking device receives information on a route for an item to be tracked. It then acquires sensor data from at least one sensor at time points from a plurality of time as the tracking device is being transported along the route in association with the item, to thereby generate a measured pattern of events for the route. The tracking device applies an algorithm to compare a multi-dimensional signature information related to the route with the measured pattern of events, the signature information having an expected pattern of events associated with the plurality of time points of the route. An instruction to trigger an action based on a result of the applying may be generated. The server generates signature information by training a machine-learning model based on data acquired by tracking devices.

### TECHNICAL FIELD

Embodiments herein relate to a tracking device, a server computer and methods for controlling operation of the tracking device for tracking an item as it is being transported from a source point to a destination point.

### BACKGROUND

In a modern environment, a vast number of goods are shipped every day between various locations, including countries and continents. For example, more and more packages, letters, bags, luggage, cargo, containers and other freight, and various other assets, goods, or items, are transported via airplanes all over the world. Both dedicated freight planes and or civil aircrafts are used in shipment chains.

Typically, goods travel from point A to point B using a variety of transportation types. A shipment chain or a logistics route, which comprises two or more legs, often includes one or two flights. For proper tracking of a shipment process for an item being transported, a sender, a logistics company, and a receiver need to know an item's location and a time at that location, to determine a current status of the shipment and delivery date and time, assess any potential delays with the shipment, address potential issues, and for other purposes. It is desirable to track items using digital services.

Although approaches to tracking items and monitoring shipment chains exist, there are nevertheless various issues that can be encountered along a shipment chain and that may not be properly identified and addressed using existing approaches. Certain events such as, e.g., changing weather, transport delays, change in transport conditions, and other external events may affect a proper and timely delivery of an item. Such events, which may be unpredictable, may be challenging to detect and address, and a sender, recipient, and other parties may not be properly and timely informed of the events and how they affect the item delivery.

### SUMMARY

An object of embodiments herein is to improve tracking of items as they are being transported from a source location to a destination location, using a server computer and a tracking device that is aware of its current position, acquires sensor data, and can detect various events.

In embodiments, the tracking device are informed of one or more of trip routes comprising legs, environments, and transportation methods involved. The tracking device, associated with an item being shipped, operates to determine its location at a given point and time. The tracking device can identify events involved in a shipment chain, or logistics route, and can control battery usage by the tracking device since it may be determined when and how to turn off a wireless transmitter (or put it into a sleep or flight mode), e.g., before an airplane take-off. The tracking device may also determine when to turn the wireless transmitter on again and continue to track the logistics route.

According to some aspects, a method performed by a server computer for controlling operation of the tracking device is provided. The method comprising:
identifying a multi-dimensional information on a route for an item to be tracked using the tracking device, the multi-dimensional information comprising a source location, a destination location, one or more intermediate locations between the source and destination locations, and a plurality of time points associated with the route and each associated with a location between the source and destination locations;
providing the multi-dimensional information on the route to the tracking device;
applying a machine-learning model to identify a multi-dimensional signature information related to the route, the signature information comprising an expected pattern of events associated with the plurality of time points of the route;
providing the multi-dimensional signature information related to the route to the tracking device; and
monitoring a status of the tracking device as the tracking device is being transported along the route in association with the item.

In some aspects, a tracking device for tracking items is provided, comprising:
a location device;
at least one sensor;
a communication module for communication with a server; and
one or more processors configured to
receive, from the server, multi-dimensional information on a route for an item to be tracked using the tracking device, the route information comprising a source location, a destination location, one or more intermediate locations between the source and destination locations, and a plurality of time points associated with the route and each associated with a location between the source and destination locations;
acquire, by the at least one sensor, sensor data at time points from the plurality of time points, as the tracking device is being transported along the route in association with the item, to thereby generate a measured pattern of events for the route;
apply an algorithm to compare a multi-dimensional signature information related to the route with the measured pattern of events, the signature information comprising an expected pattern of events associated with the plurality of time points of the route; and
to generate an instruction to trigger an action based on a result of the applying.

According to some aspects, a server computer is configured for controlling operation of a tracking device, and being configured to identify a multi-dimensional information on a route for an item to be tracked using the tracking device, the multi-dimensional information comprising a source location, a destination location, one or more intermediate locations between the source and destination locations, and a plurality of time points associated with the route and each associated with a location between the source and destination locations; provide the multi-dimensional information on the route to the tracking device; apply a machine-learning model to identify a multi-dimensional signature information related to the route, the signature information comprising an expected pattern of events associated with the plurality of time points of the route; provide the multi-dimensional signature information related to the route to the tracking device; and monitor a status of the tracking device as the tracking device is being transported along the route in association with the item.

It is furthermore provided herein a computer program comprising instructions, which, when executed by at least one processor, cause the at least one processor to perform any of the methods in accordance with embodiments herein. It is additionally provided herein a carrier comprising the computer program, wherein the carrier is one of an electronic signal, an optical signal, an electromagnetic signal, a magnetic signal, an electric signal, a radio signal, a microwave signal, or a computer-readable storage medium.

### BRIEF DESCRIPTION OF THE DRAWINGS

Examples of embodiments herein are described in more detail with reference to attached drawings in which:

FIG. 1 is schematic block diagram illustrating embodiments of a wireless communications network in which some embodiments may be implemented;

FIG. 2 is a block diagram illustrating a tracking device and a server in accordance with some embodiments;

FIG. 3 is a flowchart depicting an embodiment of a method in a tracking device in accordance with some embodiments;

FIG. 4 is another flowchart depicting an embodiment of a method in a tracking device in accordance with some embodiments;

FIG. 5 is a flowchart depicting an embodiment of a method in a sever in accordance with some embodiments;

FIGS. 6A and 6B illustrate an example of operation of a tracking device in accordance with some embodiments; and

FIG. 7 illustrates another example of operation of a tracking device in accordance with some embodiments;

### DETAILED DESCRIPTION

Example embodiments herein relate to an intelligent tracking device capable of determining and communicating its position information, as well as information about a surrounding environment, and that may determine, using a pattern matching approach, whether a current route proceeds as expected. The tracking device and a computer server may communicate over a wireless communications network with a server which handles operation of multiple tracking devices and which uses machine learning to generate expected routes, in association with expected patterns of events that may occur at various points along a route. The expected patterns of events may be used by the tracking device to determine if an observed or measured pattern of events, encountered by the tracking device, matches the expected patterns. The tracking device may generate an instruction to trigger a certain action, based on the result of the matching.

The problem for a tracking device may be that a transmitter for communicating to the outside world need to be switched off before, e.g., a take-off and that there can happen other events during the route that need to be identified to control sensors and the transmitter to be able to save battery in an intelligent way. Accordingly, embodiments of the present disclosure provide a system, devices, and methods for tracking items using the intelligent tracking device.

Professional senders and receivers of goods, as well as personal travelers, are interested in tracking and sometimes controlling (e.g., container technology., e.g. coolers, batteries etc.) at least the following:
a) Where the item is (position)
b) If it's in time according to planned route
c) How it has been handled
d) If its status has been ok (e.g. temperatures) during the transportation

Furthermore, if a package/baggage are to be tracked with online updates (sending data wirelessly to an end user) during a journey from A to B, where at least one leg is a flight, the system needs to be able to automatically switch of the transceiver while in flight.

In some aspects, methods and technology for identifying different legs during a transportation are provided. In some embodiments, when a tracking device is close to be boarding and/or is onboard an airplane, any transmitter may be shut down before a takeoff.

In some aspects, a method performed by a tracking device for tracking items, comprising at least one sensor and a communication unit for communicating with a server over a wireless communication network. In some embodiments, the method comprises
receiving, by one or more processors, from the server, multi-dimensional information on a route for an item to be tracked using the tracking device, the route information comprising a source location, a destination location, one or more intermediate locations between the source and destination locations, and a plurality of time points associated with the route and each associated with a location between the source and destination locations;
acquiring, by the one or more processors, sensor data from the at least one sensor at time points from the plurality of time points, as the tracking device is being transported along the route in association with the item, to thereby generate a measured pattern of events for the route;
applying, by the one or more processors, an algorithm to compare a multi-dimensional signature information related to the route with the measured pattern of events, the signature information comprising an expected pattern of events associated with the plurality of time points of the route;
generating, by the one or more processors, an instruction to trigger an action based on a result of the applying.

In some embodiments, the tracking device is an intelligent tracker with pre-calculated and pre-loaded patterns. The tracking device is part of an intelligent tracking system with tracking technology that uses pre-calculated and pre-loaded data route data, and movement patterns combined with sensors. The internal software uses the learned data. It may combine internal sensor information it acquires, as well as other external data about a situation, and then may send event status and/or control things such as, control transmitter(s) flight mode (on/off switch) state.

In some embodiments, pre-calculated and pre-loaded data and pattern recognition also identify events and handling during the route.

In some embodiments, the pre-loaded pattern data (calculated by the server or computer system, e.g., a backend AI/machine learning), include movement patterns and digitizes typical environmental footprints (sounds, temperature, etc.) as a data string so that the digital device/tracker knows where it is. It may learn from others, may use previously acquired information (e.g., the tracker had followed a certain route before), or it has experienced the same event such as when it was dropped, or reloaded onto a vehicle, e.g. a truck, airplane, train, etc. The tracking device communicate with the server or computer system and may learn from the other tracking devices trip information, because the system has previously recorded and learned certain patterns.

In various embodiments, a tracking device may communicate with a remote server (e.g., a computer system which may be a cloud system), and in some embodiments also with a user device, via a wireless communications network. The tracking device, also referred to herein as a tracker, may be a portable device comprising one or more processors, memory storing computer-executable instructions for execution by the one or more processors, an operating system stored in the memory, a location device (e.g., a GPS hardware), sensor(s), and transmitters, e.g., Bluetooth, GSM, 2G/3G/4G(LTE)/5G/NB-IoT, LoRa, and/or any other transmitters for communicating its position and sensor information. The tracking device may be configured to communicate, via a wireless communications network, its geographical location, determined using the device's positional technology, and other information to the server.

The tracking device may be inserted into, attached to, or otherwise associated with a container, a package, a box, a crate, a vehicle, an envelope, or with any other form which may include any suitable goods and which are collectively referred to herein as an item. In some embodiments, an item or its packaging may be associated with an Internet of Things (IoT)-Gateway (Gw). In embodiments, the tracking device associated with an item being tracked while transported is used to track and report its own (and thus the item's) location, timing, properties of the surrounding environment, and other suitable information. The tracking device in accordance with embodiments of the present disclosure may be used for tracking an item during transportation between any locations over the world, and it can be used in conjunction with any suitable logistics systems. Thus, the tracking device allows to track an item in an improved way, such that at any desired time point (associated with a location) along the route, a position and surrounding conditions of the device may be determined. Furthermore, in some embodiments, tracking of an item in accordance with embodiments of the present disclosure may allow controlling the environment around the item. For example, if the tracking device senses and reports that a temperature, humidity, or other properties of the surrounding environment deviate from expected values, which may be required, a tracking device and/or the server may instruct a proper entity (e.g., a carrier) to adjust the properties.

In some embodiments, a status and operation of the tracking device may be controlled by a server or computer system in accordance with embodiments of the present disclosure.

In some embodiments, the tracking device acquires information about the route it will follow and about an expected pattern of events (which may include events that would otherwise be unexpected) that it could encounter while en route, and the tracking device compares this information with the actual or measured information that it acquired during the route. In some embodiments, the tracking device applies an algorithm (e.g., a pattern-matching algorithm) to compare a multi-dimensional signature information related to the route with a measured pattern of events, wherein the signature information comprises an expected pattern of events associated with the plurality of time points of the route.

The tracking device may further generate an instruction to trigger an action based on a result of the applying. In some embodiments, the tracking device may perform a certain action in response to the result of the applying, as discussed in more detail below. The instruction may comprise reporting a current position of the tracking device or reporting an unexpected event. In some cases, if the tracking device determines that a current route is followed in accordance with expected pattern of events, the tracking device does not transmit any communication to the server. In this way, as the tracking device is tracking an item from a source to destination location, its battery consumption may be minimized. For example, the tracking device may not need to use GPS and other positional technology often, since it only needs to communicate to report a proper status or exceptions. Also, the tracking device may be safely used in logistics chains involving airplanes, and it may safely identify when transmitters shall be put into a sleep or flight mode. Furthermore, due to a use of smaller batteries, which is possible because a number of communications with a server is reduced, the tracking device may be of a relatively small size which allows its use in any type of a container or enclosure—even in an envelope in some cases. As a further advantage of a tracking device in accordance with embodiments of the present disclosure, it may identify anomalies faster, which allows handling failures, that may occur along the route, faster.

In some embodiments, a complete system with methods and technology is provided, for identifying different legs, transportation methods and events during a transportation using pre-loaded route-, weather-, flight-data and learned patterns.

When different legs are identified, the tracking device can not only send position and sensor data, but it can also send expected and unexpected events about the trips reloading, type of transportation and or handling.

In some embodiments, the tracking device can, using the pre-loaded data combined with sensors, explicitly identify when e.g. a tracking system with transmitter is close to be boarding/loading and are onboard an airplane. When close to boarding/loading the transmitter will be turned off by the system. It's also capable of knowing in which airport it probably is and identify when it's safe to turn on the transmitter again.

This technology and methods that can be embedded into the tracking device (or as a add on to other trackers/transmitters) can identify typical events and places during an logistics route including, but not limited to, when the tracker is boarding/onboard an airplane and shall shot down or put in “flight mode”.

In some embodiments, the system includes following parts:
1. System with route data and learned data knowledge of the logistics route including flights
2. Learned loading, reloading, sensor, time patterns from previous routes including flights
3. Multiple flight data sources including real time flight schedule sources
4. A digital tracker (any tracker/IoT GW platform with e.g. transmitter/GPS) with a radio transmitter and a location system (typically a GPS, GSM, WiFi, Beacons) other sensors like, but not limited to, time, acceleration, pressure, temp, sound (microphone) sensors. The tracker with are also pre-loaded with learned route sensor pattern and expected flight data for the specific logistics route.
5. Beacons that transmit an airplanes tail no (or other ID) onboard using a low level transmitter such as Bluetooth.

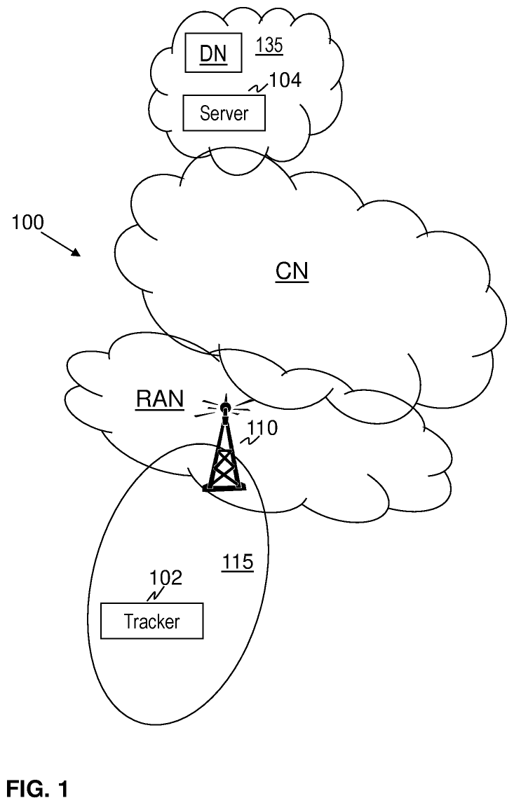

FIG. 1 is a schematic overview depicting an example of a wireless communications network 100 wherein embodiments herein may be implemented. In some embodiments, the wireless communications network 100 comprises one or more Radio Access Networks (RANs) and one or more core networks (CNs), though it should be appreciated that the wireless communications network 100 may have other configurations. The wireless communications network 100 may use a number of different technologies, such as Wi-Fi, Bluetooth, 2G, 3G, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. In some embodiments, the tracking device is a 5G-enabled device; however, embodiments are also applicable in further development of the existing wireless communication systems such as, e.g., WCDMA, LTE, and others.

In the example shown in FIG. 1, a tracking device 102 operates in the wireless communications network 100 and communicates with a server or computer system 104.

A number of network nodes operate in the wireless communications network 100 such as, e.g., a network node 110. Although not shown in FIG. 1, it should be appreciated that the wireless communications network 100 may comprise various network nodes which may communicate with the tracking device 102. The network node 110 provides radio coverage in a cell which may also be referred to as a beam or a beam group of beams, such as a cell 115 provided by the network node 110.

In various embodiments, the wireless communications network 100, comprises a system, a facility, a vehicle, or another space in which one or more tracking devices, and other devices, may operate. The system may be, for example, a warehouse, an airplane, a delivery track, a harbor, a transportation facility, an airport facility, or any other suitable system or facility, or a combination thereof.

Methods herein may be performed by the tracking device 102 and the server 104. In FIG. 1, the server 104 is shown to be in a cloud 135 which may comprise one or more Distributed Nodes (DNs). It should be appreciated, however, that the server 104 may be located at any network, including the RAN, the CN, or any other network.

A number of embodiments will now be described, some of which may be seen as alternatives, while some may be used in combination.

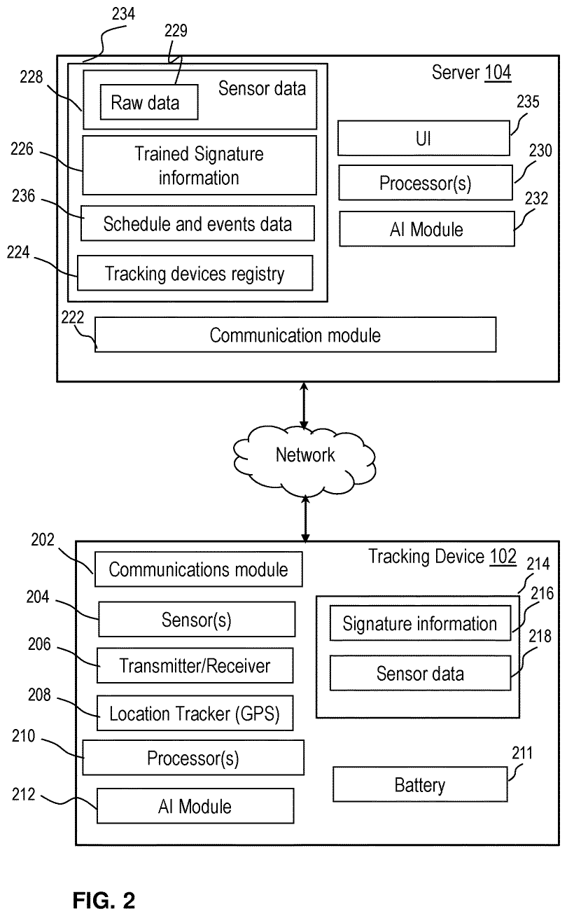

FIG. 2 illustrates an embodiment of the tracking device 102 and the computer server 104 in accordance with embodiments herein, which communicate via a wireless communications network (e.g., 2G/3G/4G/5G NB-IoT, WiFi, Sigfox, open LoRa, or any other), such as the network 100 of FIG. 1.

The tracking device 102 comprises a communications module 202, one or more sensors 204, a wireless transmitter/receiver 206 (e.g., a Bluetooth, or 4G/5G modem, etc.), a location tracker module 208 (e.g., GPS), one or more processors 210, and an artificial intelligence (AI) module 212. The tracking device also comprises memory 214 which may store computer-executable instructions for execution by the processor 210. The memory 214 comprises signature information 216 and sensor data 218 acquired by the one or more sensors 204. The AL module 212 may be stored in the memory 214 and may be executed by the one or more processors 210.

FIG. 2 also shows that the tracking device 102 may comprise a battery 211, which may be a rechargeable battery. The battery 211 may be of a relatively small size, due to improved communications between the tracking device 102 and the server in accordance with embodiments of the present disclosure, which allows manufacturing the tracking device 102 of a relatively small size. For example, in some implementations, the tracking device 102 may be small and lightweight enough to be placed in a postal envelope. It should be appreciated that embodiments herein are not limited to any specific size, weight, shape, and other features of the tracking device, and various tracking devices may be manufactured for different uses.

The communications module 202 comprises communication between the tracking device 102 and the server 104, as well as other devices, e.g., a user device. The communications module 202 may receive and process data received from the server 104, and it may format for sending and send data (e.g., sensor data) to the server 104.

The one or more sensors 204 may be any sensors, sensors, non-limiting examples of which include inertial sensors such that Inertial Motion Units (IMUs), accelerometers, gyrometers, barometric pressure sensors, video cameras, laser sensors, magnetic position sensors, Bluetooth signal strength sensors, Wi-Fi signal strength sensors, temperature sensors, humidity sensors, microphones, electromagnetic field sensing sensors, and various other sensors. Some or all of the sensor(s) 204 may acquire data as the tracking device 102 is in operation for tracking an item during item's transportation, along with the tracking device.

The sensor(s) 204 may be internal sensors or they may be associated with the tracking device 102. Furthermore, in some embodiments, the tracking device 102 may acquire data from one or more external sensors, e.g., a temperature, humidity, or other sensor(s) in a vehicle, airplane, or facility in which the tracking device 102 (and the item being tracked) are located.

A transmitter/receiver 206, which may also be referred to as in input/output interface, may be any suitable device including, e.g., a Bluetooth technology or 4G/5G modem. In some embodiments, the tracking device 102 is a 5G-enabled device. The transmitter/receiver 206 may be configured for transmitting and receiving data using any of 2G, 3G, 4G, 5G NB-IoT, WiFi, Sigfox, open LoRa, and/or any other technology. The transmitter may be an inbuilt or external transmitter, or a combination thereof. The transmitter/receiver 206 may provide data to and receive data from the communications module 202.

The tracker/device has an CPU, location device (e.g. GPS, GSM, and or beacon/indoor WiFi positioning), clock and sensors.

The location tracker module 206 determines a position of the tracking device, using, e.g., a Global Positioning System (GPS) sensor, Global Navigation Satellite Systems (GNSS)-based positioning, a Global System for Mobile Communications (GSM)-based positioning, beacon/indoor WiFi positioning, and/or another technology.

The embodiments herein may be implemented through a respective processor or one or more processors, such as the one or more processor(s) 210 of a processing circuitry in the tracking device 102, together with respective computer program code, or computer-executable instructions, for performing the functions and actions of the embodiments herein. The program code may also be provided as a computer program product, e.g., in the form of a data carrier carrying computer program code for performing the embodiments herein when being loaded into the tracking device 102. One such carrier may be in the form of a CD ROM disc. It is however feasible with other data carriers such as a memory stick. The computer program code may furthermore be provided as pure program code on a server and downloaded to the tracking device 102.

The AI module 212 applies algorithms compare a multi-dimensional signature information related to the route with the measured pattern of events.

As shown in FIG. 2, the memory 214 comprises the signature information 216 and sensor data 218. It should be appreciated that the memory 214 of the tracking device 102 may comprise any other information, which may be information received from the server 104 and/or other sources, including other tracking devices.

In some embodiments, the memory 214 comprises instructions executable by the processor(s) 210. The memory 214 may be arranged to be used to store e.g. information, indications, data, configurations, and applications to perform the methods herein when being executed in the tracking device 102.

Those skilled in the art will appreciate that the modules in the tracking device 102 described above may refer to a combination of analog and digital circuits, and/or one or more processors configured with software and/or firmware, e.g. stored in the tracking device 102. The software and/or firmware, when executed by the respective one or more processors, such as the processors described above, cause the one or more processors to carry out the actions described herein, as performed by the tracking device 102. One or more of the processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

In some embodiments, the signature information 216 may be relevant route information, identified by the server 104 and preloaded to the tracking device 102. The signature information 216 or a signature, comprising an expected pattern of events associated with the plurality of time points of the route, may be preloaded to the tracking device 102 before the tracking device 102 is used to track an item. The signature information 216 may be updated as the tracking 102 operates to track the item.

The route information, also referred to herein as a route, may comprise a source location, a destination location, one or more intermediate locations between the source and destination locations, and a plurality of time points associated with the route and each associated with a location between the source and destination location. In some embodiments, the route information may comprise a latest information about the route, airport, flight times, as well as previously learned patterns and sensor data relevant to the route. The data can also be updated during the route, e.g., flight time and or flight number changes. The route information may also comprise information on the weather (e.g., temperature, wind, precipitation, etc.) and other possible disruptions that may affect routes events.

In some embodiments, the tracking device may receive the route information along with typical events (e.g., time and type) and its sensor data signatures. A signature information may comprise one or more of the following:
Times
   Load and flight times
Transportation methods
   To and at airport
Airports
   Loading methods
   Sounds
   Expected temperature(s)
Flight number
   Flight schedule, i.e. departure and landing times
   Flight or Carrier type (e.g., Boeing 737), and sometimes airplane tail number
   Sound types, load heights, angle.

It should be appreciated that, in embodiments, the tracking device 102 may have any other components which are not shown herein. Thus, the tracking device 102 may include a clock.

In some embodiments, the tracking device 102 may have wireless beacons (or an app in loaders smart phone or digital device in load vehicle) that transmit an aircraft's tail number with a low power transmitter such as, e.g. Bluetooth used while loading or in the cargo bay. Such features may be used for tracking shipment on cargo planes. The tracker/digital device put in a bag, container, and/or goods may receive an airplane tail number identifier (ID) and compare it with the pre-loaded flight data and then know that it is being close to or inside the aircraft. This feature may be used to shut down a transmitter of the tracking device 102 while in flight, which is discussed in more detail below.

It should furthermore be appreciated that the tracking device 102, or part of its functionality (e.g., the AI module 212) may be associated with another device, such as a sensor or any other type of a device that can acquire information, and determine and report its location.

In some embodiments, a tracking device, configured to identify and trigger events, comprises a CPU and a memory, a location device, a clock, and a sensor, wherein the sensor is configured to record a measured pattern, and wherein the CPU is configured to perform a comparison between the measured pattern and pre-loaded patterns and a switch configured to trigger an action if the comparison fulfils pre-determined criteria. The tracking device may further comprise a communications device configured to transmit data about the event to a back-end AI (e.g., an AI module of the server).

In some embodiments, a sensor device for tracking a device is provided, wherein the sensor device is configured to attach to the device and comprises a transmitting unit and a sensing unit; and wherein the sensor device is further configured to:
detect entering or being present within a restricted vehicle using the sensing unit; and
shut down the transmitting unit upon detection.

In some embodiments, the sensor device may be configured to detect entering or being present by sensing internal communication within the restricted vehicle (detecting communication over certain bandwidth, communication to the air traffic controller).

In some embodiments, the sensor device may be configured to detect entering or being present by sensing audio indicating a take-off of the vehicle (e.g., microphone detecting engines).

In some embodiments, the sensor device may be configured to detect entering or being present by analyzing movement of the sensor device compared to a predetermined pattern (e.g., movement of loading the device onto the airplane).

In some embodiments, the sensor device may be configured to detect entering or being present by comparing location of the sensor device with locations of airports.

In some embodiments, the sensor device may be configured to
initate tracking of the device of between a source and destination location;
retrieve possible travel routes; and
identify travel route by a (positioning) sensor and detect entering or being present by comparing location of the sensor device with locations of airports.

In some embodiments, the sensor device performs retrieving possible travel routes retrieve flight numbers and flight time, and using the retrieved flight numbers and flight time when detecting entering or being present within a restricted vehicle. In some embodiments, the sensor device may further be configured to communicate with the back-end AI system to exchange data regarding sensed values, as well as data from other systems.

As further shown in FIG. 2, in this example, the server 104 comprises a communications module 222, tracking devices registry 224, trained signature information 226, sensor data 228, one or more processors 230, an AI module 232, a user interface 235, and a schedule and events data module 236. As shown in FIG. 2, the sensor data 228, trained signature information 226, schedule and events data, and tracking device registry 224 may be stored in memory 234.

The communications module 222 may be or may be associated with a service that receives data from the tracking device 102. The server 104 also comprises an input/output module (which may comprise a wireless receiver and a wireless transmitter) (not shown) for communicating with the tracking device 102 and other devices.

The tracking devices registry 224 may include information on tracking devices that may be registered with the server 104. For example, the server 104 may provide a service for tracking items using a tracking device. In some cases, the tracking device may be implemented as a user friendly device which may be used by a person to track, e.g., personal items during travel or shipment. In some embodiments, a service may be used by a logistics chain supplier, shipping company, etc.

In some embodiments, the trained signature information 226 comprises an expected pattern of events (e.g., a sequence of events). The trained signature information 226 may include multiple expected patterns of events, which may be generated based on previously completed (by tracking device(s)) routes for which measures patterns of events were acquired. The signature information 226 may include trained, predicted signatures generated based on various information acquired by the server 104. For example, the server 104 may generate, or predict, a signature information for a certain route when such route is requested for the tracking device 102, even if there is no exact match for that route in the trained signature information 226.

In some embodiments, the trained signature information 226 may comprise a data pattern from sensor data combined with known situation data (time, actual location, weather, etc.) that gives a footprint of an actual event or situation. As an example, a signature data or information may include a signature (or part of a signature) such as, e.g., “travelling in a van in rain during daytime.”

The sensor data 228 may be stored data acquired by the server 104 from the tracking device 102 and/or other tracking devices. The sensor data 228 may also be acquired in real time, as the server 104 receives the data from the tracking device 102. In some embodiments, as shown in FIG. 2, the sensor data 228 may comprise a raw data module 229, which may be, e.g., a sub-service that transforms sensor data and stores tagged raw data, which may be used by the AI module 232, to train the model to identify new patterns, which may be transformed into signatures.

The memory 234 may be any combination of one or more computer-readable media or device. The computer-readable storage device may be, for example, but not limited to, an electronic, magnetic, optical, electromagnetic, or semiconductor system, apparatus, or device, or any suitable combination of the foregoing. Non-limiting examples of the computer readable storage device include a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. The computer-readable storage device may be any tangible medium that can contain, or store computer program instruction for execution by one or more processors. The memory 234 may be part of the server, or it may be a separate storage associated with the server 104. In some implementations, the memory 234 is located in the cloud.

In some embodiments, the memory 234 comprises instructions executable by the processor(s) 230. The memory 234 may be s arranged to be used to store e.g. information, indications, data, configurations, and applications to perform the methods herein when being executed in the server 104.

Those skilled in the art will appreciate that the modules in the server 104 described above may refer to a combination of analog and digital circuits, and/or one or more processors configured with software and/or firmware, e.g. stored in the server 104. The software and/or firmware, when executed by the respective one or more processors, such as the processors described above, cause the one or more processors to carry out the actions described herein, as performed by the server 104. One or more of the processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein may be implemented through a respective processor or one or more processors, such as the one or more processor(s) 230 of a processing circuitry in the server 104, together with respective computer program code, or computer-executable instructions, for performing the functions and actions of the embodiments herein. The program code may also be provided as a computer program product, e.g., in the form of a data carrier carrying computer program code for performing the embodiments herein when being loaded into the server 104. One such carrier may be in the form of a CD ROM disc. It is however feasible with other data carriers such as a memory stick. The computer program code may furthermore be provided as pure program code on a server and downloaded to the server 104.

The AI module 232, which may be stored in the memory 234 and executed by the one or more processors 230, may apply a machine-machine-learning model to identify a multi-dimensional signature information related to a route. The machine-machine-learning model may be trained using various data, including sensor data stored in the sensor data 228 and sensor data which may be received in real time, schedule and events data stored in the schedule and events data module 236, as well as schedules (and changes to schedule), events, weather information, transportation information, which may be received in real time. The trained machine-machine-learning model may generate a trained multi-dimensional signature information, also referred to as a signature herein. Multiple signatures may be generated and stored, in association with various routes or portions of the routes. The signature information may be provided to the tracking device 102 when the tracking device 102 is prepared for being shipped along with an item to be tracked. In some embodiments, the signatures provided to the tracking device 102 may be adjusted in real time, e.g., based on information acquired by the tracking device 102 and/or the server 104. For example, if the server 104 becomes aware (e.g., based on information received from the tracking device 102, other tracking device(s), or other sources, e.g., a weather forecast source, a traffic controller, etc.) of events or changes in the events which may affect a current route being followed by the tracking device 102, the server 104 may inform the tracking device 102 of these changes.

In some embodiments, the server 104, e.g., the AI module 232 and/or other components, integrate external data, data from flight data systems, pre-planned flight schedules and live flight changes and iterations, as well as weather and traffic status.

The user interface 235, which may be any suitable user interface and dashboard, may display information relevant to the tracking device 102, a route, a status of the route and the tracking device 102 (and thus of the item), and any other information. The user interface 235 may be presented by an application or service provided or associated with the server 104, and it may allow tracking a current status of the tracking device 102 including its location on a map. The user interface 235 may present any other information that may be used to assess, monitor, and control current conditions of an environment around the tracking device, including in some cases conditions of an immediate environment, e.g., a temperature or humidity around the item being shipped.

In some embodiments, the user interface 235 may present the trackers data, the route, battery status, events (e.g., dropped package, loading, etc.), offline (in flight) or on-board last mile route typical (truck movement registered by accelerometers), and any other information.

In some embodiments, a method performed by a tracking device for identifying and triggering events is provided. The method comprises recording a measured pattern, performing a comparison between the measured pattern and pre-loaded patterns, and triggering an event if the comparison fulfils pre-determined criteria. In some embodiments, the method further comprises transmitting data about the event to a server (e.g., a back-end AI). In some embodiments, the method further comprises transmitting data about the measured pattern and the triggered event for later learning and analysis by the back-end AI. In some embodiments, the method further comprises receiving updated pre-loaded patterns from the back-end AI.

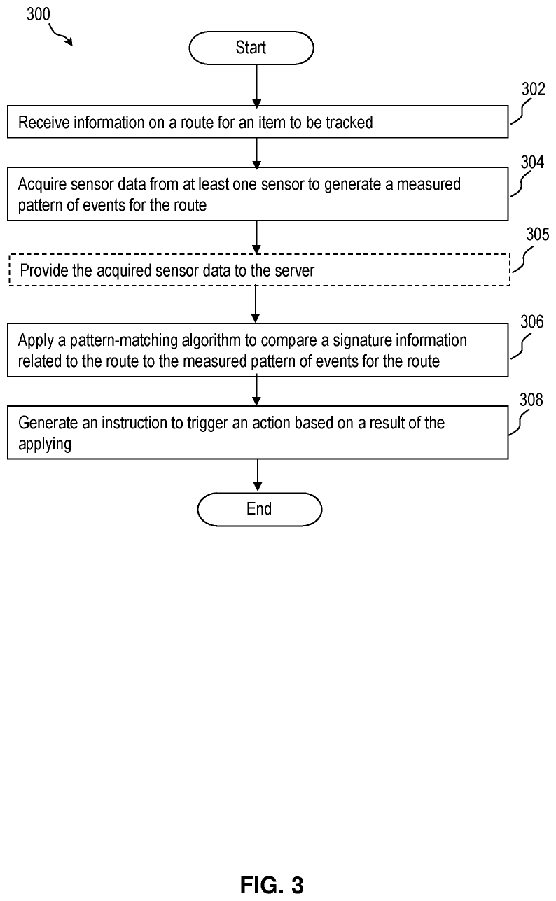

FIG. 3 shows an example embodiment of a method or process 300 performed by a tracking device in accordance with embodiments of the present disclosure, such as, e.g., tracking device 102 of FIGS. 1 and 2, for tracking an item and communicating with a server via a network such as, e.g. the wireless communications network 100.

The method comprises the following actions, which actions may be taken in any suitable order. Optional actions are referred to by dashed boxes in FIG. 3.

Action 302

The tracking device receives information on a route for an item to be tracked.

In some embodiments, the tracking device receives, by one or more processors, multi-dimensional information on the route for the item to be tracked using the tracking device. The route information, also referred to as the route, comprises a source location, a destination location, one or more intermediate locations between the source and destination locations, and a plurality of time points associated with the route and each associated with a location between the source and destination locations. Thus, the route from the source location to the destination location may be formed by two or more legs each extending between two destinations, which each may extend between adjacent source, intermediate, or destination points.

In some embodiments, the route may be received from the server. In some information, the route may additionally or alternatively be received from a user device. In some embodiments, a user, logistics provider, shipping company, or other entity may provide an approximate route, or a portion of the route (e.g., addresses of the source and destination locations), and the server selects an appropriate route including the intermediate locations and the plurality of time points. In some embodiments, the server provides a service through which the tracking technology and methods in accordance with the present disclosure may be utilized, and a user interface provided by the service allows viewing a status of the tracking device and receiving other related information.

In some embodiments, the route and expected related timing events may be represented as vectors of multi-dimensional points.

Action 304

The tracking device acquires sensor data from at least one sensor to generate a measured pattern of events for the route. In some embodiments, the tracking device performs acquiring, by the one or more processors, sensor data from the at least one sensor at time points from the plurality of time points, as the tracking device is being transported along the route in association with the item, to thereby generate the measured pattern of events for the route.

The sensor data may be acquired using various sensors, non-limiting examples of which include inertial sensors such that Inertial Motion Units (IMUs), barometric pressure sensors, video cameras, laser sensors, magnetic position sensors, Bluetooth signal strength sensors, Wi-Fi signal strength sensors, temperature sensors, humidity sensors, microphones, electromagnetic field sensing sensors, and various other sensors.

The sensor data may be processed for further analysis. In some embodiments, raw (i.e. unprocessed) sensor data is sent to the server, which can be then stored at, e.g., raw (sensor) data module 229 of FIG. 2.

In some embodiments, each time point from the plurality of time points in the signature information is associated with a type of sensor data to acquire at the time point, and acquiring the sensor data from the at least one sensor at time points from the plurality of time points comprises acquiring a type of sensor data. For example, the signature information may indicate that an image data may be taken at a certain time, and the tracking device acquires an image data at a respective time point. It should be appreciated that the time points may not be exact specific times, but may be approximate times. In some embodiments, the time points may be adjustable, including in real time, i.e. at the tracking device is used to track an item along a certain route. For example, if there is a delay in the tracking device being in the actual route, subsequent time points expected along the route may be adjusted for the delay.

Furthermore, in some embodiments, one or more of a plurality of times defined along a route may be associated with certain events from a plurality of events. Thus, the tracking device may track a sequence of events, which may occur at certain times and at certain locations.

In some embodiments, an event from the plurality of events may be, e.g., a change in a type of transportation carrying the tracking device, in a type of movement (e.g., stopped, in a vehicle, on a flight, being dropped, etc.), a change in a surrounding environment (e.g., a rain, storm, traffic jam, etc.), a change in scheduling, etc. The event may not necessarily be a change, and it may also be a continuous event, for example, an act of the tracking device being present in a moving vehicle.

Furthermore, the tracking device may acquire sensor data of more than one type at any given time period, even if only a certain type of sensor data may be used for matching with data associated with the signature information. The tracking device may process acquired raw sensor data in an appropriate matter, to convert the data into a format appropriate for comparison with the signature information.

Action 305

The tracking device may provide the acquired sensor data to the server. The sensor data may be provided to the server as the sensor data is acquired, for example, for each time point along the route. In some embodiments, the sensor data may be provided periodically or if a certain event is detected. The sensor data is provided to the server so that the server may assess the current situation and status of the tracking device and surrounding environment. Also, the server storage and processes the sensor data, for analysis, generating expected signature information, and updating expected signature information.

In some embodiments, the tracking device receives live tracking information such as position, tracker sensor data (acceleration, temperature, barometric pressure, battery, identified pattern (by the tracker)). The tracking device may change the preloaded information, e.g. new information about the route is received from external sources, such as new flight information, weather information, etc.

Action 306

The tracking device applies a machine-learning algorithm to compare a multi-dimensional signature information related to the route to the measured pattern of events for the route. The signature information comprises an expected pattern of events associated with the plurality of time points of the route. The application of the machine-learning algorithm may occur at each time point from the plurality of time points, to match the signature information with the actual acquired data, which may comprise sensor information and various other information.

In some embodiments, the machine-learning algorithm comprises a pattern-matching algorithm.

Action 308

The tracking device generates an instruction to trigger an action based on a result of the applying.

In some embodiments, applying the machine-learning algorithm comprises comparing the multi-dimensional signature information with the measured pattern of events at each time point from the plurality of time points associated with the route, and the instruction to trigger an action based on the result of the applying comprises is generated for times points from the plurality of time points to report a proper status of the tracking device or to report an exception.

During its operation and communication with the server, the tracking device may provide various information to the server. Thus, in some embodiments, the tracking device transmits to the server one or more of: information about the instruction to trigger an action, the measured pattern of events, the acquired sensor data, and a position and acquired sensor data at a time point from the plurality of time points

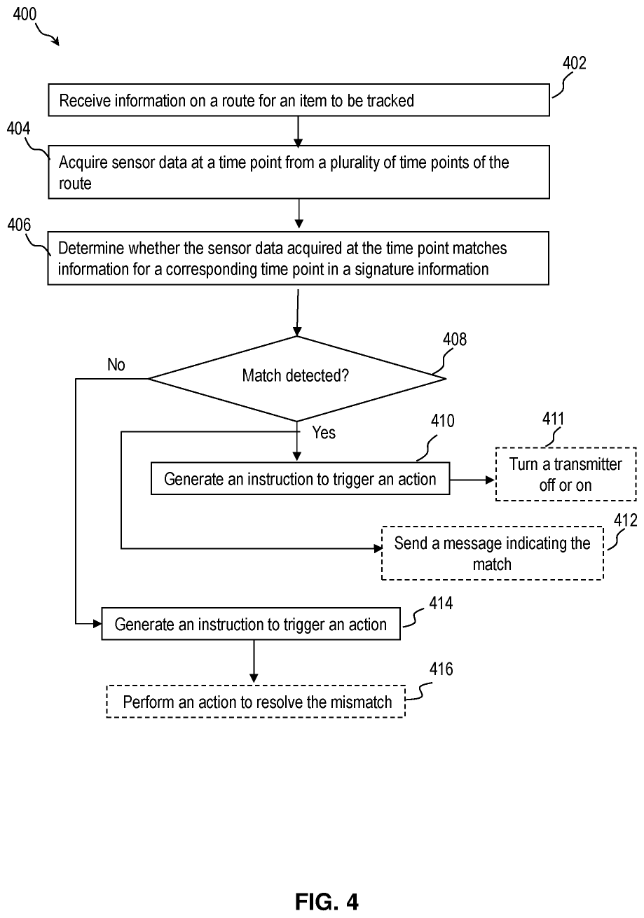

FIG. 4 shows an example embodiment of a method 400 performed by a tracking device in accordance with embodiments of the present disclosure, such as, e.g., tracking device 102. The method or process 400 comprises some of the same acts as in the process 300 of FIG. 3, as discussed in more detail below.

The method comprises the following actions, which actions may be taken in any suitable order. Optional actions are referred to by dashed boxes in FIG. 4.

Action 402

The tracking device receives information on a route for an item to be tracked. The route information is similar to the route information described in connection with block 302.

Action 404

The tracking device acquires sensor data from at least one sensor to generate a measured pattern of events for the route. The process of acquisition of the sensor data is similar to the process described in connection with block 404.

Action 406

The tracking device applies a machine-learning algorithm to compare a signature information related to the route to the measured pattern of events for the route.

Action 408

The tracking device determines (e.g., by applying the pattern-matching algorithm) whether a match is detected. If the match has been detected, e.g., if the information acquired in association with a time point in the measured pattern of events matches information associated with that time point in the expected pattern of events in the signature, the process 400 may follow to block 410 where an instruction to trigger an action is generated. Additionally, in some embodiments, as shown in FIG. 4, when the match is detected, the tracking device may send a message to the server (and/or to another entity, e.g., to a user device) indicating the proper status.

If the match is not detected, the process may follow to block 412 where an instruction to trigger an action is generated, as discussed in more detail below.

Thus, in some embodiments, as shown in this example, the tracking device may generate an instruction to trigger an action in both cases—when a match is detected and when a match is not detected. The instructed action may be a different action, and it may be performed by the tracking device or the action (e.g., further instructions, adjustment of parameter(s) of the surrounding environments, etc.) may be requested from the server and/or another system or device.

Action 410

The tracking device generates an instruction to trigger an action is. In this case, the action may be relevant to the detected match and it may depend on a current status of the tracking device, e.g., its location, timing, and surrounding circumstances.

The instruction to trigger the action based on the result of the applying (block 406) may be generated to report a proper status of the tracking device. In embodiments, the instruction to trigger an action based on the result of the applying is generated for a fewer times points from the plurality of time points that all of the plurality of time points. Thus, the tracking device may not communicate its status to the server and/or to another device when it is determined that the route is followed normally, without failures, delays, etc. Also, the status of the tracking device and its surrounding environment may not be reported if the properties of the surrounding environment meet expected properties and/or if the tracking device is en route without expected changes (e.g., on a flight, in a truck, in a ship, etc.).

In some embodiments, the action may be a physical action performed by the tracking device. For example, as shown at block 411, the action may comprise temporary turning off a transmitter or putting the transmitter into a sleep mode when the at least one sensor detects that the tracking device is entering or being present within a space at which the item is to remain for a certain time period.

Furthermore, in some embodiments, the instruction to trigger an action comprises an instruction to perform one or more of:
acquiring additional data from the at least one sensor,
transmitting information about the instruction to trigger an action to the server,
storing information about a current status of the route,
transmitting the information about the current status of the route to the server,
requesting a control instruction from the server, and
performing a local action that comprises a physical action by the tracking device.

However, in some embodiments, when a proper status of the tracking device is determined, an action comprises a report message.

In some embodiments, a flight tracking system with a digital tracker that has been pre-loaded with data patterns that has been learned by the server (e.g., the server's AI module) can be applied in several solutions and verticals. The server's AI module collects internal data (sensor data) and external data (data from a different system such as, e.g., data system, whether information, or similar) into the AI module to determine status/location or similar information for an item being tracked.

A digital tracker with pre-loaded data patterns is informed what sensor data to look for and what to sense (combination of sensor data).

When a pre-loaded data pattern occurs, the tracking device may identify the pattern by matching according to a pre-learned pattern, and may trigger an action.

An event type may trigger various actions, e.g. the tracking device may be instructed to one or more of:
a) record data from the tracking device's sensors
b) send data about the event
c) store detailed data for later learning and analysis by the server's AI module
d) perform a local action, such as, e.g., play a sound, light up something, vibrate to get attention and/or control another digital device connected wirelessly and/or via a wired connection to the tracking device. The local action may be triggering an alarm, controlling a relay, sending data to another computer or another tracker connected wirelessly or via a wired connection into a digital network.

Action 411

The tracking device may turn off its transmitter (e.g., transmitter/receiver 206 of FIG. 2) when at least one sensor of the tracking device detects that the tracking device is entering or being present within a space at which the item is to remain for a certain time period. The space may be, for example, an airplane, a truck, a ship, etc. Thus, while the tracking device is in transit and its location within the space does not change, battery power may be saved by turning the transmitter off or entering a sleep (or flight) mode.

In some embodiments, the at least one sensor may detect that the tracking device is entering or being present within the space at which the item is to remain for a certain time period by detecting one or more of:
a communication over a certain bandwidth,
a communication from an air traffic controller,
an audio signal indicative of an airplane take-off,
at least one of a flight number, a flight time, and a flight tail number,
an airport information, and
a movement pattern indicative of the tracking device entering or being present within the vehicle at which the item is to remain for a certain time period.

The sensor(s) may detect other events indicative of the tracking device entering the space, as embodiments herein are not limited in this respect. In some embodiments, the at least one sensor, such as an accelerometer, detects an airplane taking off.

As an example, when the tracking device is near boarding an airplane, the sensor(s) may detect a sound of the airplane's engine and may detect that the tracking device is on the airplane. In response to detection, the transmitter may be turned off or may be caused to enter a sleep (e.g., flight) mode. This may occur near boarding the airplane, or once inside the airplane. Thus, during the flight, the tracking device may not transmit its status or other data.

At or near arrival, the sensor(s) may detect it, by sensing any of the above events and/or other events. The at least one sensor thus detect that the tracking device is exiting or has exited the space. The tracking device may then turn on the transmitter or cause it to exit the sleep mode when the at least one sensor detects that the tracking device is exiting or has exited the space. The tracking device thus resumes transmitting messages to the server.

Action 412

The tracking device sends a message to the server indicating the match. The message may be a report of a proper status of the tracking device. The message may be sent to a server such as the server 104 (FIGS. 1 and 2), to another tracking device, a user device, a controller of a current carrier of the tracking device, the network (e.g., the wireless communication network 100), or to any other entity. In some embodiments, the message, such as an “OK” message, is sent to the server. The message may additionally or alternatively comprise a current location of the tracking device, though it should be noted that the tracking device may send its location if the match is not detected, as well.

Action 414

The tracking device generates an instruction to trigger an action. The instruction to trigger the action based on the result of the applying (block 406) may be generated to report an issue with the route.

In some embodiments, the instruction to trigger an action comprises an instruction to perform one or more of:
acquiring additional data from the at least one sensor,
transmitting information about the instruction to trigger an action to the server,
storing information about a current status of the route,
transmitting the information about the current status of the route to the server,
requesting a control instruction from the server, and
performing a local action that comprises a physical action by the tracking device.

Action 416

In some embodiments, the tracking device performs an action that may facilitate resolve the mistmach. The action may be any of the above action, e.g., acquiring additional data from the at least one sensor, transmitting information about the instruction to trigger an action to the server, storing information about a current status of the route, transmitting the information about the current status of the route to the server, requesting a control instruction from the server, and performing a local action that comprises a physical action by the tracking device.

In some embodiments, the action performed by the tracking device may be generating an audio signal, a visual signal, generating a vibrating signal, another signal, or any combination thereof, to indicate a potential issue and to get attention (e.g., of a personnel in an airport, a driver of a vehicle, etc.), and/or to control another digital device connected wirelessly and/or via a wired connection to the tracking device. As further non-limiting examples, the local action may be triggering an alarm, controlling a relay, sending data to another computer or another tracking device connected wirelessly or via a wired connection to a network comprising the tracking device.

The process 400 shown in FIG. 4 may be repeated during the route, for each time point of the plurality of time points defined for the route. Thus, after processing at blocks 411, 412, and 416 is completed, the process may return to block 404, at which further sensor data will be acquired by the tracking device, at a subsequent time point from the plurality of time points of the route. The process 400 thus operates iteratively until the route is completed.

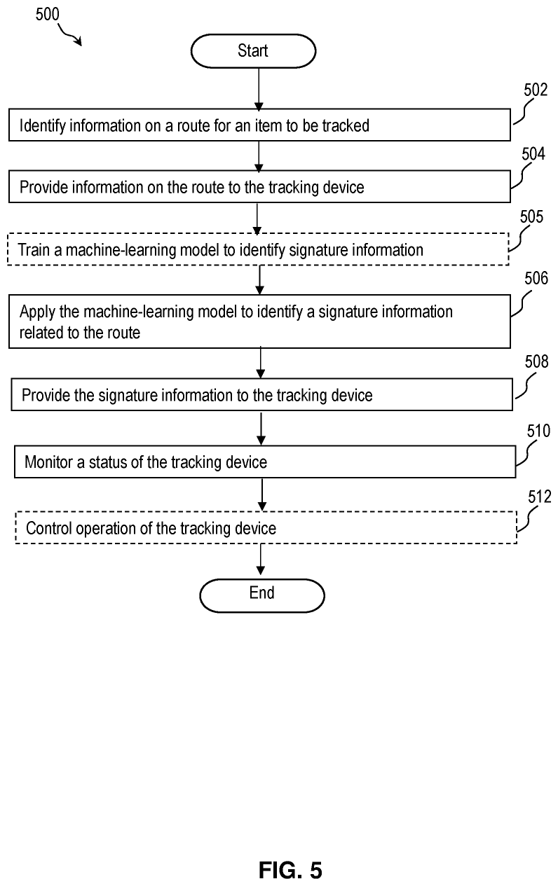

FIG. 5 shows an example embodiment of a method or process 500 performed by a server computer or server in accordance with embodiments of the present disclosure, such as, e.g., server 104, for controlling operation of a tracking device, such as tracking device 102. The server 104 comprises one or more processors, one or more computer-readable storage devices, and computer-executable instructions stored on the computer-readable storage devices. The method 500 comprises executing the computer-executable instructions by the one or more processors to perform acts of the method.

The process 500 comprises the following actions, which actions may be taken in any suitable order. Optional actions are referred to by dashed boxes in FIG. 5.

The process 500 may start, for example, when the server is initiated to provide at least route and signature information to the tracking device for tracking a certain item. For example, a user interface provided by an application or service supported by the server may be used to acquire information about a route (or a trip) along with the item is to sent and tracked. Any other relevant information may be acquired, e.g., required or desired arrival time, conditions of a surrounding environment during transportation of the item (e.g., temperature, humidity, etc.).

Action 502

The server identifies information on a route for an item to be tracked. The server identifies, by the one or more processors, a multi-dimensional information on a route for an item to be tracked using the tracking device, the route information comprising a source location, a destination location, one or more intermediate locations between the source and destination locations, and a plurality of time points associated with the route and each associated with a location between the source and destination locations.

In some embodiments, one or more of the time points from the plurality of points coincide with respective intermediate locations. In some embodiments, one or more of the time points are associated with a finer gradation of locations than the intermediate locations. For example, intermediate locations may be cities, airports, or other destinations at which typically a change in the transportation takes place. As an example, the source location may be Stockholm, the destination location may be Houston, TX, US, and the intermediate location may be London, UK, though one or more other destinations (e.g., shipment facilities) may be defined as intermediate locations. Time points from the plurality of points may be defined for each destination, transportation type, and in some cases for potential events during transportation along the route. A number of time points, and their associated locations and events may be defined based on information available about the route. For example, if this, or a similar, route has previously been fulfilled and related information was acquired, more time points and with more related details may be defined for that route, and a signature information for the route may be identified by the server with more precision. If, however, the requested route is new and/or less information is available, fewer points may be defined.

In some embodiments, one or more “training” tracking devices may be sent along a route, e.g., a previously unknown route or a route for which it is required to obtain information with high precision and accuracy (e.g., for transportation of time-sensitive items), to acquire training information about the route.

Action 504

The server provides information on the route to the tracking device. The server may provide any other information to the tracking device, including, e.g. multi-dimensional external scheduling and event information related to the route. The server may also provide updated, including in real time, information related to the route to the tracking device.

Action 505

The server trains a machine-learning model to identify multi-dimensional signature information related to routes. The training may be performed using one or more of sensor data, routes data, weather data, situation data, schedules data, transport data, and unexpected events data. The schedules data may be related to schedules of flights, ships, vehicles (e.g., trucks or vans), trains, etc.

The machine-learning model may be trained using any technique, such as, e.g., Naïve Bayes, decision tree, logistic regression, linear regression, support vector machine, random forest, a clustering algorithm, an artificial neural network (e.g., a convolutional neural network, recurrent neural network, spiking neural network, etc.), etc.

Action 506

The server identifies a signature information related to the route. In some embodiments, the server may apply, by the one or more processors, the trained machine-learning model to identify the multi-dimensional signature information related to the route. The signature information may comprise an expected pattern of events associated with the plurality of time points of the route. The signature information may include various information on a number and durations of legs, a type and number of transportation used to deliver the item from the source to the destination, schedules, expected weather conditions at certain locations, etc. In some embodiments, each time point from the plurality of time points may be associated with a type of sensor data to acquire at the time point.

The signature may be selected by the server for the route based on various factors, including similarity of pretrained signatures (stored in the server) to the requested route,

Action 508

The server provides the signature information to the tracking device. In some embodiments, the server provides to the tracking device an updated signature information comprising an updated expected pattern of events associated with the plurality of time points of the route.

Action 510

The server monitors a status of the tracking device as the tracking device is being transported along the route in association with the item. The server may receive from the tracking device one or more of: information about an instruction to trigger an action, a measured pattern of events, acquired sensor data, and a position and acquired sensor data at a time point from a plurality of time points.

The server may also receive a status, e.g., a proper status, message from the tracking device, indicating that the current trip proceeds according to the signature information for that trip or route. In some cases, the server may receive an exception from the tracking device, indicating that there is an issue with the current trip.

In some embodiments, the server communicates the status of the tracking device to a user computing device.

Action 512

The server optionally controls operation of the tracking device. For example, in some embodiments, the server may receive an indication from the tracking device of a certain condition encountered by the tracking device along the route, and the server may in response instruct the tracking device to provide to additional sensor data. The server may then analyze the condition and determine whether actions.

Furthermore, in some embodiments, the server may communicate with a carrier, facility, vehicle, or any other system that is involved in fulfilling the route. For example, if the tracking device detects a deviation from a temperature (or other parameters) required for transporting an item, the tracking device reports this to the server which may inform the system in which the tracking device and the item are located, and request adjustment to the temperature.

The embodiments described in connection with FIGS. 2, 3, 4, and 5 will now be further discussed and exemplified below. The embodiments below may be combined with any suitable embodiment above.

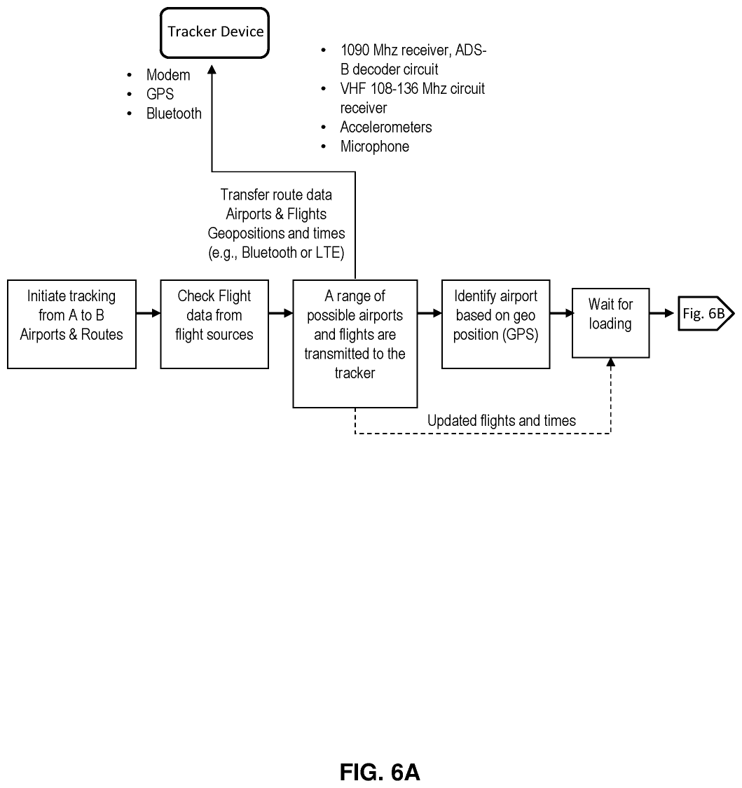

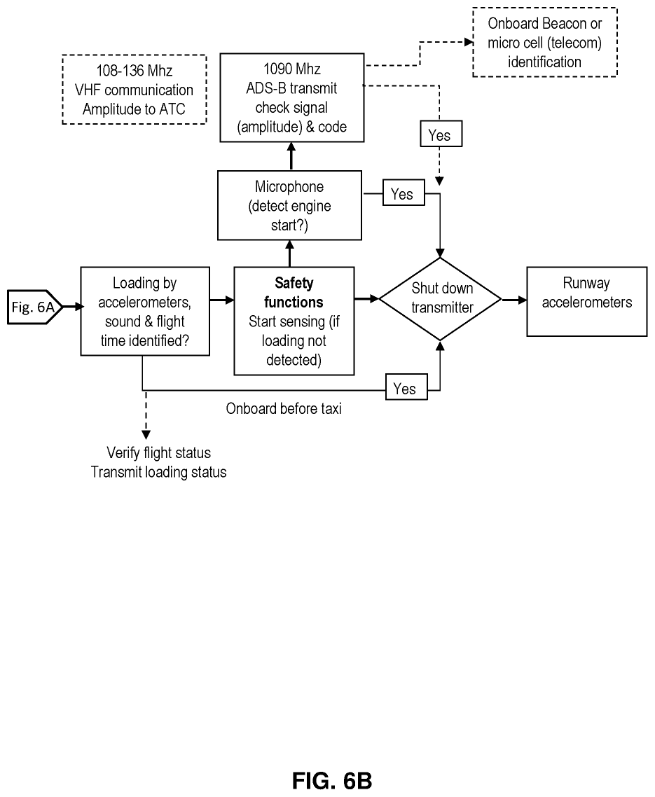

FIGS. 6A and 6B illustrate an example of a process of tracking an item using a tracking device that can receive and transmit data wirelessly using private or public networks. The process in FIGS. 6A and 6B illustrates shutting down and turning on a transmitter of a tracking device in accordance with embodiments of the present disclosure. The tracking devices includes a low energy transmitter such as a Bluetooth transmitter/receiver that can detect a flights tail number ID signal (part of this or other logistics systems).

Shut Down Transmitter Process

The tracker/device (i.e., the tracking device) can, by combining the sensor data with pre-loaded pattern and route data, know exactly when the tracker/device is loaded on a plane and can shut down the tracker in time before loading on an airplane.
a) The tracker/device may activate loading pattern identification (accelerometers, airport/airplane sounds, etc.) before take-off time or while transferred to the plane.
b) When loading pattern is detected, or with a security margin, the tracker/device will turn the transmitter off.
c) It may verify that its onboard by also measuring GPS signal. If it's close to 0 and engine sounds are on, its confirmed that the tracker on board. Shut down was correct.
d) The airplane (this system can be delivered with a beacon), or the loading vehicle, or an activated app on a smartphone, may be equipped with a beacon that transmits the aircrafts tail number. The tracker will identify the beacon signal and the flights tail number (the actual aircraft) and compare it with the pre-loaded data as a confirmation that the process is done ok.
e) If the system would miss all patterns and detect its status, it will use the accelerometers to detect the airplane's acceleration while taking off and then immediately shut down the transmitter.

Turn on the Transmitter Process

The tracker, e.g., GPS and CPU, are put in sleep mode during flight time (pre-loaded) plus a security margin.
a) Before expected landing the accelerometers are put on. Check barometric pressure.
b) When landing “touch down” is measured by accelerometers and/or barometric pressure, a timer can be adjusted according to a flight schedule.
c) The system waits for off-loading patterns (sounds—accelerometers).
d) After a while, the GPS checks for signals. If signals are picked up with signal levels expected outside an airplane, the tracker/device is on, and if “ok” transmitter state, and the transmitter can be turned on to send position and other data.

The above sequence can be tuned and learned to improve its performance every time. The tracker will store sensor data for later analysis. As more data is put into the AI (e.g., AI module 232 of the server 104) after each trip and is analyzed, learned and stored, new patterns can be identified that can be used by other trackers.

By using this system and method, a logistics route or personal trip with luggage can used even with multiple flight legs and safely be tracked all the way. If changes of the route occur during the tracking time the tracker will be updated while in transfer.

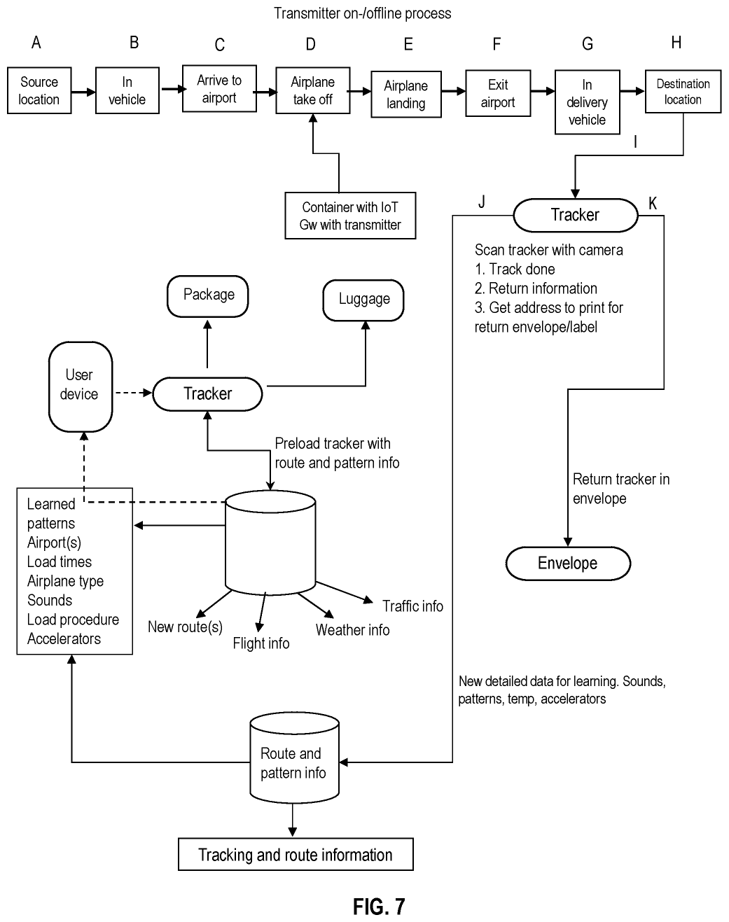

FIG. 7 shows an example of scenario in which the tracking device, e.g., tracking device 102, in accordance with the present disclosure may operate.

In some embodiments, the software of the tracking device may store a pre-planned and pre-loaded transportation and flight routes with one or several legs. The pre-loaded data can be updated during the route/trip with more accurate data.

In some embodiments, the device/trackers software compares the route with internal sensor data such as position, clock, etc., and match with learned patterns of typical movements in trucks, loading vehicles, planes that taxi (e.g., using accelerometers x,y,x), sounds (e.g., from an airport, airplanes, etc.) and the pre-loaded flight schedule and depart time.

An item or goods typical route or journey—logistics route—is often divided into several parts (legs). For example, non-limiting examples may comprise:
a) First mile using a van or a small truck
b) Reloaded into bigger truck and or container for flights (on or more legs).
c) Reloaded into a truck
d) Reloaded into a last-mile delivery using delivery service/postal service.

A personal bag or luggage is managed by the user at an airport and
a) Packaged by ground personnel into airplane
b) May be transferred by airport vehicles to another airport/airplane during transfer
c) Second flight
d) Delivered to the end user at the destination airport or
e) By delivery serve at the destination if the luggage got lost or late during handling.

In some embodiments, the tracking device, or the tracker, is able to identify events, legs on a route and when the internal or an external radio transmitter is to be turned off before a flight departs and turned on when the tracking device detects that it is has landed.

FIG. 7 shows the following
0) The tracker is switched on and goes online with an inbuilt or external transmitter and connects to a wireless radio network, typically 2g/3g/4g/5g NB-IoT, WiFi, Sigfox, open LoRa, or similar that may be developed.
1) or 2) The tracker is updated with route data and pattern information by the server (or the back-end system)
   a. A to H (from origin to destination).
   b. Legs and expected times and transportation methods, flights etc., if known
   c. Calculated expected flights numbers (airport, carrier, flight number, etc.) and legs. Typically, the same flights are used.
   d. Learned aircraft/airport patterns
      i. Loading truck driving patterns
      ii. Loading patterns (angle, acceleration, sounds)
      iii. Sound patterns (airport, aircraft type (engine sound when starting))
      iv. Taxi patterns
      v. Acceleration pattern (last resort for shut down)
   e. Learned transportation patterns
      i. Transportation methods (truck, van) for identifying last mile
   f. Event patterns
      i. Dropped item
      ii. Thrown item
      iii. Rolling item
      iv. Reloading
   g. Weather info
      i. temperature and barometric pressure are appropriate references.

Use Case Example

This example involves tracking an item using the tracking device that is delivered to the airport using a van and is loaded onto an airplane. In this example, a tracking system, such as a tracking device (e.g., tracking device 102) and a server (e.g., server 104), can identify locations and situations, by matching, e.g.:
a) pre-loaded data from External Data Sources
b) pre-loaded learned and trained data patterns from Cloud AI (e.g., from the server)
c) pre-loaded timing and Situation Data about current trip from A to B
d) with learned patterns and sensor information.

The External Data Sources may be, e.g., sources with information about typical travel and logistics trip and time schedule conditions such as:
Flight data systems with flight number, airplane tail number, departure and landing times
Train and bus time schedules
Traffic conditions, queue length on roads
Weather data

The Situation Data may be, e.g., data and data patterns learned from defined and trained situations (events) that typically occur during the trip which will be tracked from A to B such as, e.g.:
Loading events
In transport by truck
Waiting
Arriving at airport
Dropped
Loaded on an Airplane
In transport by Van

In this example, a package with medicine is to be transported from Stockholm via London to Houston, USA. A tracking device in accordance with embodiments of the present disclosure may be inserted into, e.g., a package with the medicine. The tracking device may be configured to measure, among other things, a temperature of the medicine in the package.

A server, e.g., a cloud system, is initiated (e.g., as shown in FIG. 5), and the route is planned by searching for a route from Stockholm to London and from London to Houston.

The server searches its sources and planning, and a trip plan or route is suggested. Information on the route may be in a format that allows manually adjusting the route. The server may scan its sources of flight data etc., and/or a route information may be provided to the server from a user device operated by, e.g., a user or a logistics supplier. In this example, a plan is the following:
A) Pick up at Stockholm Warehouse at 09:00 by a currier using mini vans.
B) Expected to arrive to Arlanda Airport (ARN) at 10:00
C) Loaded on BA234 with departure at 11:40 and origin Heathrow with landing at 14:20
D) Transferred to BA 346 to Houston at 16:50 and arriving at 22:35
E) Picked up by currier from hospital at airport.
F) Done

A process of pre-loading data into the tracking device may comprise:
A) A server gathers a plan for the route and fetches all learned Signatures (i.e. the signature information, as described herein) for an expected trip from London to Houson.
a. Time schedule and expected event and waiting times
b. Expected and trained Signatures related to the events, other known common situations along this route, and other events such as, e.g. dropped package of the type used, etc.
c. Known base 5G cell tower IDs and carriers used along the trip
d. Weather forecast as input to Signatures (bad weather and season can, e.g., be used to adjust timing thresholds in the model—higher probability for delays)
B) The data is packaged as a data set
C) The data is transferred to the tracking device via a wireless data link or locally using, e.g., Bluetooth.
D) The trip can start at 09:00 next day (or near 09:00—the server may know typical delays for the pickup location). The tracking device starts applying a pattern matching algorithm.

A process of training a machine-learning model by processor(s) of the server may comprise:
The server may be trained before a trip by sending one or several training tracking devices along a Route from A—B—from Stockholm to London.
The server may identify known common patterns and add them to the common Signature library as variants that extends the model.
The server may identify a new situation, and it may receive (which may be upon a request) an instruction to define a certain situation (with meta data and possibly rules) and/or suggest a situation that it may be similar to the required route. Thus, a manual feedback may be received by the server regarding a signature.

The tracking device may be pre-loaded with a route and timing information. The tracking device may store and transmit (e.g., except while in the air) acquired data. In some cases, the tracking device transmits all sensor data at all times.

As described above, the tracking device may apply a pattern-matching algorithm to compare a multi-dimensional signature information related to the route with a measured pattern of events. The signature information may be received from the server. The tracking device, e.g., its processor(s) and AI module, may determine whether information acquired at a time point from the measured pattern of events matches information associated with a respective time point in the signature information. The match may be identified when, e.g., the acquired information is similar to the predicted information (e.g., it is a near match), and the match does not need to be exact in some cases. A level of similarity may depend on type of the information, requirements for the route, requirements for the item, etc. For example, in the present example, a certain temperature is required to be maintained using shipment of the medicine, and even small deviations from the requirement temperature may be indicative of a lack of a match.

If an unexpected event or signature occur, the tracking device may
a. Check with GPS for reference or Telecom network for Cell ID
b. If OK no problems—>report a position and OK
c. If NOT OK—>report an exception and wait for instructions e.g., reroute information with new Signatures.

As one example only, in the present case, the following events may be encountered by the tracking device along the route:
A) The tracking device has been updated with a new Signature information
   a. Weather data shows pouring rain.
B) At 09:00 the algorithms start by the timing vectors route information
C) At near 09:00 the temperature sensor drops to 12 degrees
   a. Matches with van temperature in the Signature information in September during rain
   b. Everything OK, in van
D) At 09:30 the Sound matches with a van travelling on a highway in rain
   a. Everything OK, on route
E) At 10:20 the Gyro sensors changes in acceleration matches with a movement and stop on a horizontal surface
   a. Everything OK, expected waiting time, waiting area
   b. Send OK position in waiting
F) At 10:45 the Gyro detect movement and microphone detects sounds from jet engines
   a. Everything OK, expected flight time with BA234 at 11:20
   b. Check GPS
   c. Send OK, soon loading at airplane turning flight mode on. Standby 12 h
   d. Shut down local modem—>put into flight mode.
   e. Waiting for load movements to confirm flight time and standby time.
   f. Log other Signature events locally, such as dropped package.

Additional Use Cases

The server system and the tracking device in accordance with embodiments of the present disclosure may be used in various applications where sensing specific positions, movements, and events (e.g., environment patterns) is required for identifying events during tracking. For example, an object such as, e.g., another item, a machine pattern, a human, or an animal, may be tracked in accordance with embodiments of the present disclosure.

In such embodiments, the digital tracking device may have an onboard CPU and software that process sensor data from one or more of the sensors, e.g., accelerometers, position, temperature, pressure, humidity, sound, image sensors, and any other suitable sensors. The tracking device may track one or more objects associated therewith, and it may store and/or communicates data from the sensors to the server. In operation, the tracking device matches a measured pattern of events to an expected pattern of events in a signature received from the server. Based on the matching, e.g., application of a machine-learning algorithm, the tracking device may identify events and perform programmed actions related to the event. The tracking device may reuse sensor data from other trackers in a certain sector/segment and or a use case.

The following solutions and use cases may use a tracking device in accordance with embodiments of the present disclosure:
Animals: Track dogs, horses, cattle, etc.
   Detect movement patterns
   Detect dangerous behavior
   The tracking allows reacting when it is detected that an animal does not feel well and/or needs medical attention
Boats: Track movements at sea and in harbor
   Detect if a person gets overboard
   Detect windy or bad weather
   Detect a possible damage to a boat, e.g., by movements in harbor
Vehicles/items
   Detect patterns when driving in specific conditions
   Detect patterns when the vehicle is tampered with

It is herein disclosed a system comprising
Main backend system has tracker register, route information, latest learned patterns.
Backend receives live tracking information such as position, tracker sensor data (acceleration, temperature, barometric pressure, battery, identified pattern (by the tracker)). Tracker back end might change the pre-loaded info e.g. new information about the route is received from external sources, such as new flight info, whether info.
External data integration. Integrates data from flight data systems. Pre-planned flight schedules and live flight changes and iterations. Also, Weather and traffic status are usable sources.
Machine learning and AI. Learns from all routes. Timing, loading compared to flight schedule. Differences between carriers (flight numbers etc.). The system will improve with more routes. Patterns are identified and preload schemas updated so that trackers can get better pre-loaded data the next run.
User interface and dashboard that shows the trackers data, the route, battery status, events (dropped package, loading), offline (in flight) or on-board last mile route typical (truck movement registered by accelerometers)
Optional wireless beacons (or an app in loaders smart phone or digital device in load vehicle) that transmit an aircraft's tail number with a low power transmitter such as Bluetooth used while loading or in the cargo bay. Could be good on cargo planes. The tracker/digital device put in the bag and or goods receives the tail no id and compare it with the pre-loaded flight data and then know that its being close too or inside the aircraft—>shut down the transmitter.

Embodiments herein may relate to:
A method performed by a tracking device for identifying and triggering events, the method comprising
   recording a measured pattern;
   performing a comparison between the measured pattern and pre-loaded patterns; and
   triggering an event if the comparison fulfils pre-determined criteria.
The method according to embodiment above, further comprising transmitting data about the event to a back-end AI.
The method according to embodiment above, further comprising transmitting data about the measured pattern and the triggered event for later learning and analysis by the back-end AI.
The method according to embodiment above, further comprising receiving updated pre-loaded patterns from the back-end AI.
A tracking device configured to identify and trigger events, which tracking device comprises
   a CPU and a memory;
   a location device;
   a clock;
   a sensor; and
wherein the sensor is configured to record a measured pattern, and wherein the CPU is configured to perform a comparison between the measured pattern and pre-loaded patterns and a switch configured to trigger an event if the comparison fulfils pre-determined criteria.
The tracking device according to embodiment above, further comprising a communications device configured to transmit data about the event to a back-end AI.
Sensor device for tracking a device wherein the sensor device is configured to attach to the device and comprises a transmitting unit and a sensing unit; and wherein the sensor device is further configured to:
detect entering or being present within a restricted vehicle using the sensing unit; and
shut down the transmitting unit upon detection.
The sensor device according to embodiment above, being configured to detect entering or being present by sensing internal communication within the restricted vehicle (detecting communication over certain bandwidth, communication to the air traffic controller)
The sensor device according to any embodiments, being configured to detect entering or being present by sensing audio indicating a take-off of the vehicle. (E.g. microphone detecting engines)
The sensor device according to any embodiments, being configured to detect entering or being present by analysing movement of the sensor device compared to a predetermined pattern. (movement of loading the device onto the airplane)
The sensor device according to any embodiments, being configured to detect entering or being present by comparing location of the sensor device with locations of airports.
The sensor device according to any embodiments, further being configured to
   initate tracking of the device of between a source and destination location;
   retrieve possible travel routes;
   identify travel route by a (positioning) sensor and detect entering or being present by comparing location of the sensor device with locations of airports.
The sensor device according to any embodiments, when retrieving possible travel routes retrieve flight numbers and flight time, and using the retrieved flight numbers and flight time when detecting entering or being present within a restricted vehicle.
The sensor device according to any of the embodiments, further configured to communicate with a back end AI system exchanging data regarding sensed values as well as data from other systems.

It is herein disclosed Pre-loading data patterns and learn digital wireless trackers to understand and identify events in many different solutions verticals.

The flight tracking system with a digital tracker that has been pre-loaded with data patterns that has been learned by a back-end systems AI can be applied in several solutions and verticals. The back-end system AI collects internal data (sensor data) and external data (data from a different system such as data system, whether information or similar) into the AI system to determine status/location or similar for the tracked object.

A digital tracker with pre-loaded data patterns is learned what sensor data to look for and what to sense (combination of sensor data).

When a pre-loaded data pattern occurs, the trackers software will identify the pattern by matching according to a pre learned pattern and trigger an event.

The event type could trigger several things e.g. get the tracker to
e) record things from its sensors (in more detail)
f) send data about the event
g) store detailed data for later learning and analysis by the back-end AI
h) Perform local action like Play a sound, light up something, vibrate to get attention and or control another digital device connected wirelessly and or wired to the tracker. It could be triggering an alarm, control a relay, send data to another computer or another tracker connected wirelessly or weird into a digital network.

Other Solution Sectors and Data to Preload

The system with pre-loaded data patterns into trackers can be reused in several other solution sectors where tracking and sensing specific position and movement-, environment patterns are vital for identifying interesting events for the user that tracks other objects than items/vehicles in logistics, e.g. another item, machine pattern, human and or animal.

The main processes involve the same.

A digital tracker with sensors
Digital device that can receive and send data to a back-end system
Onboard CPU and software that process sensor data (all or a few sensors)
   Position
   Accelerometers
   Temperature/pressure/humidity
   Sound(s)
   Images
Tracks its objects, store and or communicates data from sensors
Match sensor patterns with pre-loaded data patterns
Identify events and perform programmed actions related to the event
1. Reuse sensor data from several trackers in a specific sector/segment and or use case
2. Use machine learning/AI and analyze the patterns and match events with real scenarios
3. Learn other trackers from the knowledge by preload new patterns and events specifically needed by the tracker each time it's used and or for s specific track use case.

It should be appreciated that the above examples are not limiting in any way, as the technology in accordance with embodiments of the present disclosure is not limited to any specific application, and it may be used in various scenarios where tracking one or more of any type of items, including live objects, is required. As other examples, a tracking device and server system, and methods therein, in accordance with embodiments of the present disclosure, may be used to track patients in hospital or outpatient settings, such that patient's movements and other behavior, as well as surrounding environment, may be monitored for certain patterns that may be indicative of a required medical attention.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

1. A method performed by a server computer for controlling operation of a tracking device, the method comprising:
identifying, by the one or more processors, a multi-dimensional information on a route for an item to be tracked using the tracking device, the route information comprising a source location, a destination location, one or more intermediate locations between the source and destination locations, and a plurality of time points associated with the route and each associated with a location between the source and destination locations;
providing the multi-dimensional information on the route to the tracking device;
applying, by the one or more processors, a machine-learning model to identify a multi-dimensional signature information related to the route, the signature information comprising an expected pattern of events associated with the plurality of time points of the route;
providing the multi-dimensional signature information related to the route to the tracking device; and
monitoring, by the one or more processors, a status of the tracking device as the tracking device is being transported along the route in association with the item.

2. The method of claim 1, further comprising training the machine-learning model to identify multi-dimensional signature information related to routes, wherein the training is performed using one or more of sensor data, routes data, weather data, situation data, schedules data, transport data, and unexpected events data.

3. The method of claim 1, further comprising providing to the tracking device an updated signature information comprising an updated expected pattern of events associated with the plurality of time points of the route.

4. The method of claim 1, further comprising communicating the status of the tracking device to a user computing device.

5. A method performed by a tracking device for tracking items, comprising at least one sensor and a communication unit for communicating with a server over a wireless communication network, the method comprising:
receiving, by one or more processors, from the server, multi-dimensional information on a route for an item to be tracked using the tracking device, the route information comprising a source location, a destination location, one or more intermediate locations between the source and destination locations, and a plurality of time points associated with the route and each associated with a location between the source and destination locations;
acquiring, sensor data from the at least one sensor at time points from the plurality of time points, as the tracking device is being transported along the route in association with the item, to thereby generate a measured pattern of events for the route;
applying, by the one or more processors, an algorithm to compare a multi-dimensional signature information related to the route with the measured pattern of events, the signature information comprising an expected pattern of events associated with the plurality of time points of the route; and
generating, by the one or more processors, an instruction to trigger an action based on a result of the applied algorithm.

6. The method of claim 5, further comprising transmitting to the server one or more of: information about the instruction to trigger an action, the measured pattern of events, the acquired sensor data, and a position and acquired sensor data at a time point from the plurality of time points.

7. The method of claim 5, comprising receiving the multi-dimensional signature information from the server.

8. The method of claim 5, comprising receiving from the server an updated signature information comprising an updated expected pattern of events associated with the plurality of time points of the route.

9. The method of claim 5, further comprising obtaining a multi-dimensional external scheduling and event information related to the route.

10. The method of claim 5, wherein:
applying the algorithm comprises comparing the multi-dimensional signature information with the measured pattern of events at each time point from the plurality of time points associated with the route; and
the instruction to trigger an action based on the result of the applied algorithm is generated for times points from the plurality of time points to report a proper status of the tracking device or to report an exception.

11. The method of claim 10, wherein the instruction to trigger an action based on the result of the applied algorithm is generated for a fewer times points from the plurality of time points that all of the plurality of time points.

12. The method of claim 5, wherein:
each time point from the plurality of time points is associated with a type of sensor data to acquire at the time point; and
acquiring the sensor data from the at least one sensor at time points from the plurality of time points comprises acquiring a type of sensor data.

13. The method of claim 12, wherein the applying comprises, for a time point from the plurality of time points:
determining whether sensor data acquired at the time point matches information for a corresponding time point in the signature information;
when a match is detected, sending a message to the server indicating the match; and
when a match is not detected, generating the instruction to trigger an action, the instruction indicating an action to perform in the absence of the match.

14. The method of claim 5, wherein the instruction to trigger an action comprises an instruction to perform one or more of:
acquiring additional data from the at least one sensor;
transmitting information about the instruction to trigger an action to the server;
storing information about a current status of the route;
transmitting the information about the current status of the route to the server;
requesting a control instruction from the server; and
performing a local action that comprises a physical action by the tracking device.

15. The method of claim 14, wherein the physical action by the tracking device comprises:
temporary turning off a transmitter or putting the transmitter into a sleep mode when the at least one sensor detects that the tracking device is entering or being present within a space at which the item is to remain for a certain time period; and
turning on the transmitter or exiting the sleep mode when the at least one sensor detects that the tracking device is exiting or has exited the space.

16. The method of claim 15, wherein the at least one sensor detects that the tracking device is entering or being present within, or exiting or has exited, the vehicle at which the item is to remain for a certain time period by detecting one or more of:
a communication over a certain bandwidth);
a communication from an air traffic controller;
an audio signal indicative of an airplane take-off;
at least one of a flight number, a flight time, and a flight tail number;
an airport information; and
a movement pattern indicative of the tracking device entering or being present within the vehicle at which the item is to remain for a certain time period.

17. The method of claim 5, further comprising modifying the signature information based on the acquired sensor data and/or based on external information received from one or more of a server and another tracking device.

18. A server computer for controlling operation of a tracking device, the server computer comprising one or more processors, the server computer being configured to perform:
identifying, by the one or more processors, a multi-dimensional information on a route for an item to be tracked using the tracking device, the route information comprising a source location, a destination location, one or more intermediate locations between the source and destination locations, and a plurality of time points associated with the route and each associated with a location between the source and destination locations;
providing the multi-dimensional information on the route to the tracking device;
applying, by the one or more processors, a machine-learning model to identify a multi-dimensional signature information related to the route, the signature information comprising an expected pattern of events associated with the plurality of time points of the route;
providing the multi-dimensional signature information related to the route to the tracking device; and
monitoring, by the one or more processors, a status of the tracking device as the tracking device is being transported along the route in association with the item.

19.-21. (canceled)

22. A tracking device for tracking items, comprising:
a location device;
at least one sensor;
a communication module for communication with a server; and
one or more processors, the tracking device being configured to:
receive, from the server, multi-dimensional information on a route for an item to be tracked using the tracking device, the route information comprising a source location, a destination location, one or more intermediate locations between the source and destination locations, and a plurality of time points associated with the route and each associated with a location between the source and destination locations;
acquire, by the at least one sensor, sensor data at time points from the plurality of time points, as the tracking device is being transported along the route in association with the item, to thereby generate a measured pattern of events for the route;
apply an algorithm to compare a multi-dimensional signature information related to the route with the measured pattern of events, the signature information comprising an expected pattern of events associated with the plurality of time points of the route; and
generate an instruction to trigger an action based on a result of the applying.

23. (canceled)
